(19) United States
(12) Patent Application Publication
(10) Pub. No.: US 2006/0186277 A1
(43) Pub. Date: Aug. 24, 2006

(54) Wall mounted television receiver

(76) Inventor: Paul Miyashiro, Pompano Beach, FL (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 11/031,852

(22) Filed: Jan. 6, 2005

(51) Int. Cl. G12B 9/00; H04N 5/66; E04F 19/00

(52) U.S. Cl. 248/27.1; 348/739; 348/825; 52/36.4; 52/173.1

(57) ABSTRACT

A combination television receiver and mounting wall adaptor comprises, in combination, a fixed wall having a rectangular hole placed in the wall at a convenient height for viewing a television program; a television receiver providing a television screen; and a mounting plate having: a means for mounting the television receiver on a rear surface of the mounting plate, an opening of a size for exposing the television screen of the television receiver, a first means for engaging joining a lower portion of the mounting plate with a lower edge of the hole in the wall for supporting the mounting plate on the wall, and a second means for engaging enabled for locking and unlocking an upper portion of the mounting plate with an upper edge of the hole in the wall for holding the mounting plate within the hole in the wall.

### BACKGROUND OF THE INVENTION

1. Related Applications: none

2. Field of the Invention

This invention relates generally to television receivers and more particularly to the manner in which such receivers may be mounted on or within a wall structure and the mechanical interface between the wall structure and the receiver.

4. Description of Related Art

The following art defines the present state of this field and each disclosure is hereby incorporated herein by reference:

Takahasi, U.S. Pat. No. 6,807,051 discloses a display apparatus with a speaker unit that is generally small in a depthwise dimension but that can generate sound of a good quality in the form of a television receiver includes a plasma display panel, a front panel having an opening through which a display face of the plasma display panel is exposed, and a back cover attached to the front panel for covering the back of the plasma display panel, with the speaker units disposed between the front panel and the back cover. The television receiver further includes a partition wall plate for covering the back of the display panel such that a space is formed between the partition wall plate and the back cover, and each of the speaker units is disposed in the space.

Vargas, U.S. Pat. No. 6,809,295 discloses a television and oven combination device includes an oven having a back wall, front wall, a pair of side walls and a top wall. A flat-panel monitor has a viewing side, a rear side, a bottom edge, a top edge and a pair of side edges. At least one monitor support is attached to the back wall of the oven. The at least one monitor support includes an elongated member having an upper end and a lower end. The elongated member is vertically orientated. A coupler is attached to the upper end for coupling the elongate member to the flat-panel monitor.

Chesser, et al U.S. Pat. No. 6,615,551 discloses a media wall for supporting various types of media, such as plasma screen or flat screen television sets, as well as other types of thin media, includes an upright vertical wall to which the media is mounted. The wall may include a pair of sidewalls mounted to a back face of the vertical wall, as well as a shelf extending forwardly from the vertical wall. At least one aperture may be included for enabling power or data cables to be inserted through the wall from the front to the back. A video camera support may be mounted on the vertical wall. The wall may be pivotable about a vertical axis to allow easy access to the rear of the wall for setting up and adjusting the electrical cabling used to support the media.

Fenner, et al U.S. Pat. No. 6,473,138 discloses a television receiver monitor intended to be built into a wall and used in connection with an audio/video entertainment center which can be adapted to provide various visual aspects corresponding to the control capabilities of the user. When only a bezel surrounding the screen is visible, all controls are made through a control center unit of the audio/video entertainment center, so that the user must have a high degree of knowledge about the overall system, whereas when the bezel and a control panel are visible, the user need not extensively involve himself with the audio/video entertainment center except to control the audio portion of the program. When confronted with an unsophisticated or underage user, a speaker grill is provided in addition to the bezel and control panel, so that no interaction with the audio/video entertainment center is required by the user in order to enjoy a video and audio program.

Gretz, U.S. Pat. No. 6,093,890 discloses a mounting device primarily for low voltage wall mounting in which can be mounted communication cable, television cable, fiber optics, or similar low voltage communication devices. The device has a frame, an integral reinforcing flange fitted into a rectangular hole on the wall, and two flags which are rotated by front mounted screws for grabbing the rear surface of the wall and serve to tighten the mounting device securely to the wall.

Our prior art search with abstracts described above teaches that it is known to mount a television receiver in a wall structure. Thus, the prior art shows, flat panel television receivers, mounting brackets and methods of mounting. However, the prior art fails to teach the instant improved device for mounting a television receiver in a wall panel. The present invention fulfills this need and provides further related advantages as described in the following summary.

### SUMMARY OF THE INVENTION

The present invention teaches certain benefits in construction and use which give rise to the objectives described below.

In one of the best mode preferred embodiments of the present invention, a combination television receiver and mounting wall adaptor comprises, in combination, a fixed wall having a rectangular hole placed in the wall at a convenient height for viewing a television program; a television receiver providing a television screen; and a mounting plate having: a means for mounting the television receiver on a rear surface of the mounting plate, an opening of a size for exposing the television screen of the television receiver, a first means for engaging joining a lower portion of the mounting plate with a lower edge of the hole in the wall for supporting the mounting plate on the wall, and a second means for engaging enabled for locking and unlocking an upper portion of the mounting plate with an upper edge of the hole in the wall for holding the mounting plate within the hole in the wall.

A primary objective of the present invention is to provide an apparatus and method of use of such apparatus that yields advantages not taught by the prior art.

Another objective of the invention is to provide an adaptor plate for mounting a flat panel television receiver within a wall space.

A further objective of the invention is to provide a combination adaptor and television receiver capable of being easily mounted and dismounted in a wall cutout.

A still further objective of the invention is provide a means for mounting a television receive on a wall structure.

Other features and advantages of the embodiments of the present invention will become apparent from the following more detailed description, taken in conjunction with the accompanying drawings, which illustrate, by way of example, the principles of at least one of the possible embodiments of the invention.

### BRIEF DESCRIPTION OF THE DRAWINGS

The accompanying drawings illustrate at least one of the best mode embodiments of the present invention. In such drawings:

FIG. 1 is a perspective front view of a television receiver adaptor plate;

FIG. 2 is a perspective rear view thereof;

FIG. 3 is a perspective view thereof showing the adaptor plate mounted in a wall cutout and supporting a television receiver;

FIG. 4 is a side elevational view thereof showing the manner in which the adaptor plate and television receiver are placed in a wall cutout, said cutout shown in section view; and

FIG. 5 is a side elevational view as shown in FIG. 4 with the adaptor plate and television receiver shown engaged with the wall.

### DETAILED DESCRIPTION OF THE INVENTION

The above described drawing figures illustrate the present invention in at least one of its preferred, best mode embodiments, which is further defined in detail in the following description. Those having ordinary skill in the art may be able to make alterations and modifications in the present invention without departing from its spirit and scope. Therefore, it must be understood that the illustrated embodiments have been set forth only for the purposes of example and that they should not be taken as limiting the invention as defined in the following.

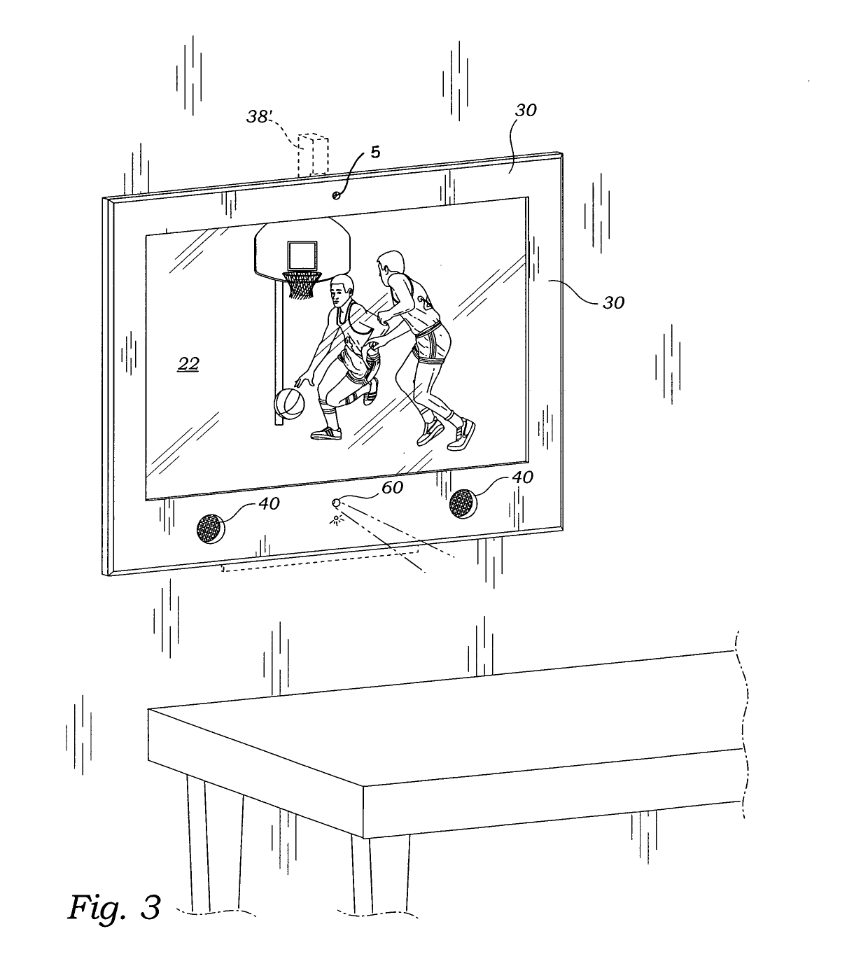

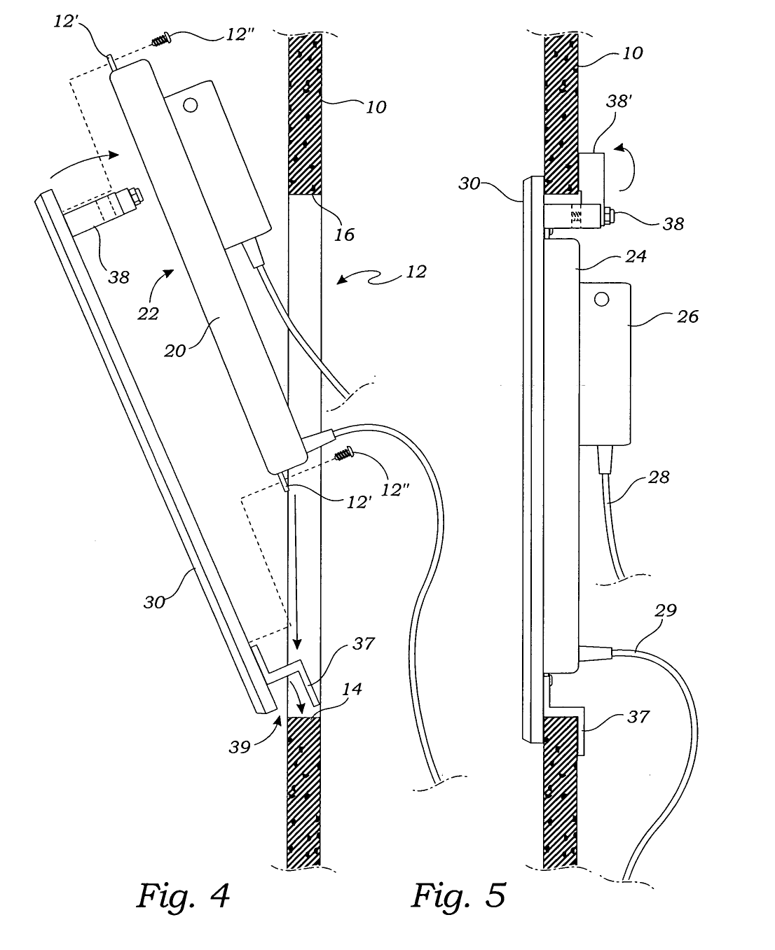

One embodiment of the present invention is a combination television receiver and mounting wall apparatus. In this embodiment, a fixed mounting wall 10 has a rectangular hole 12 (FIG. 4) therein, the hole 12 placed in the wall 10 at a convenient height for viewing a television program as would be known to those of skill in the art. Please refer to FIG. 3 of the drawings. A television receiver 20 of the invention, as for instance, a Magnavox model SLV770, an LCD technology television screen, provides a television screen 22. Further, a mounting plate 30 includes a means for mounting including 12 (mounting holes), 12′ (mounting tabs) and 12″ (screws). On a rear surface 32 of the mounting plate 30, the television receiver 20 is mounted and the plate 30 provides an opening 34 of a size for exposing the television screen 22 of the television receiver 20. A first means for engaging 36 joins a lower portion 30′ of the mounting plate 30 with a lower edge 14 of the hole 12 in the wall 10 for supporting the mounting plate 30 on the wall 10. A second means for engaging 38 is enabled for locking and unlocking an upper portion 30″ of the mounting plate 30 with an upper edge 16 of the hole 12 in the wall 10 for holding the mounting plate 30 within the hole 12 in the wall 10.

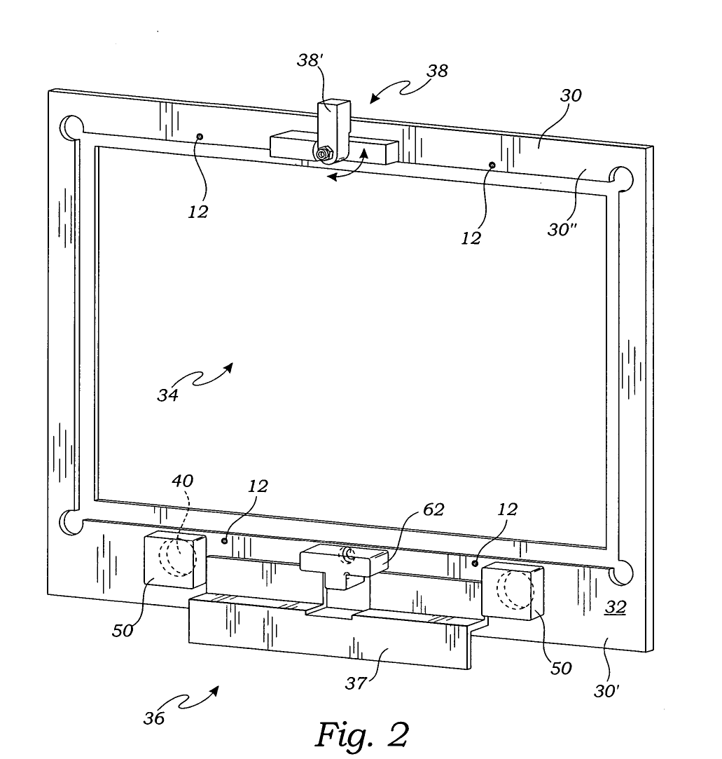

Preferably, the first engaging means 36 is a bracket as shown in FIG. 2, which is fixed to the rear surface 32 of the mounting plate 30 in a position adjacent to the lower edge 14, the bracket providing a flange 37 spaced apart from the mounting plate 30 thereby forming a channel 39 sandwiching the lower edge 14 of the wall 10.

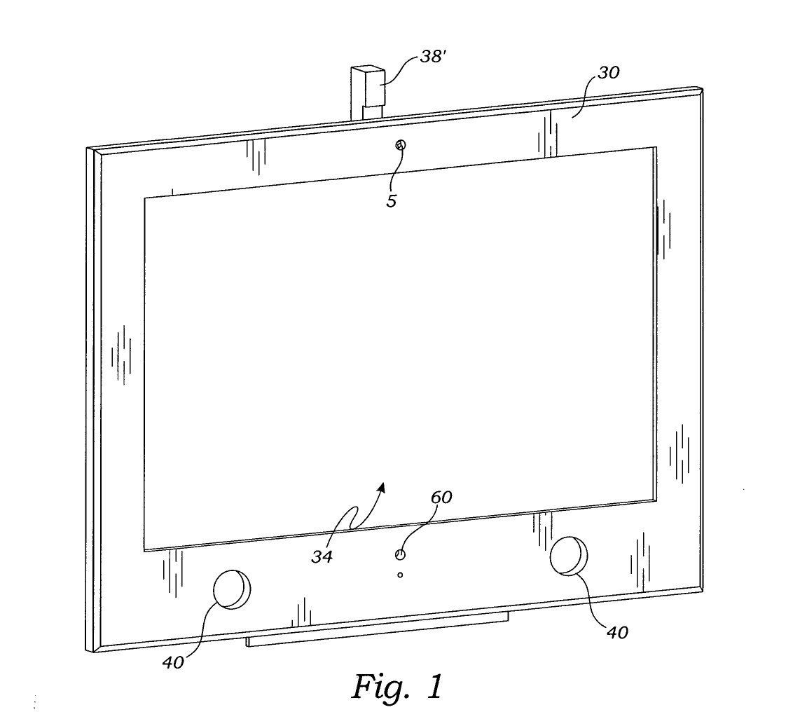

Preferably, the second engaging means 38 includes a bar 38′ rotationally mounted on the rear surface 32 of the mounting plate 30, the bar 38′ positionable (FIGS. 1, 2, 3 and 5) for sandwiching the upper edge 16 of the hole 12 in the wall 10 between the mounting plate 30 and the bar 38′ for securing the mounting plate 30 on the wall 10. The bar 38′ is alternately positionable (FIG. 4) for releasing the upper edge 16 of the hole 12 in the wall 10 for disengaging the mounting plate 30 from the wall 10.

Preferably, at least one first aperture 40 in the mounting plate 30, and most preferably, two said first apertures 40 are formed in the mounting plate 30. At least one standard loudspeaker 50, and preferably two said loudspeakers 50 are mounted on the rear surface 32 of the mounting plate 30 for projecting a television sound track through the aperture(s) 40. See FIGS. 2 and 3.

Preferably, at least one second aperture 60 is formed in the mounting plate 30, and at least one remote signal sensor 62 is mounted on the rear surface 32 of the mounting plate 30 for receiving a remote signal through the at least one second aperture 60. See FIG. 2. This sensor is well known in the art as a receiver for an infrared signal from a television remote control device.

Referring to FIG. 5 we see that the television receiver 20 further includes a flat panel display unit 24 and an electronics unit 26 comprising a television tuner. The television receiver 20 receives television signals through a first cable 28 and receives power through a second cable 29 which carries low voltage (12 VDC) from a wall socket mounted transformer apparatus (not shown) that is well known in the art. Referring now to FIG. 1, we see that an access hole 5 is provided in plate 30 for accepting a screw driver (not shown) for turning the bar 38′ from the face of the mounting wall 10 so as to allow locking the television receiver 20 in place and for removing it at a later time as necessary for maintenance.

In an alternate embodiment, the present invention comprises the wall mounted television receiver 20 and mounting plate 30 as described above. In this embodiment we do not include the wall 10. However, in the above embodiment, it is considered novel to include the wall 10 as to the manner of mounting the plate 30.

In yet a further embodiment, the invention comprises merely the means for mounting the television receiver 20, i.e., mounting plate 30 as described above. This plate 30 is novel for its combination of features and enablement for mounting onto the wall 10 as shown in FIG. 4.

A still further embodiment of the present invention comprises a method for mounting the television receiver 20 in the wall 10 comprising the steps of forming the rectangular hole 12 in the wall 10 the hole 12 providing the upper edge 16 and the lower edge 14; mounting the television receiver 20 on the rear surface 32 of the mounting plate 30; forming the opening 34 in the mounting plate 30 of a size for exposing the television screen 22 of the television receiver 20; fixing the first means for engaging 36 on the mounting plate 30 and resting the first means for engaging 36 onto the lower edge 14 of the hole 10; and fixing a second means for engaging 38 on the mounting plate 30 and engaging the second means for engaging 38 with the upper edge 16 of the hole 10.

This embodiment may include the further steps of: forming the second engaging means 38 as a bar; rotationally mounting the bar for alternately sandwiching the upper edge 16 of the hole 12 in the wall between the mounting plate 30 and the bar for securing the mounting plate 30 on the wall 10, and alternately positioning the bar for releasing the upper edge 16 of the hole 12 in the wall 10 for disengaging the mounting plate 30 from the wall 10.

The enablements described in detail above are considered novel over the prior art of record and are considered critical to the operation of at least one aspect of one best mode embodiment of the instant invention and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or elements of the embodiments of the herein described invention and its related embodiments not described are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the invention and its various embodiments or that a single element may be substituted for two or more elements in a claim.

Changes from the claimed subject matter as viewed by a person with ordinary skill in the art, now known or later devised, are expressly contemplated as being equivalents within the scope of the invention and its various embodiments. Therefore, obvious substitutions now or later known to one with ordinary skill in the art are defined to be within the scope of the defined elements. The invention and its various embodiments are thus to be understood to include what is specifically illustrated and described above, what is conceptually equivalent, what can be obviously substituted, and also what essentially incorporates the essential idea of the invention.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. A combination television receiver and mounting wall apparatus comprising in combination:
a) a fixed wall having a rectangular hole therein, the hole placed in the wall at a convenient height for viewing a television program;
b) a television receiver providing a television screen;
c) a mounting plate having:
i) a means for mounting the television receiver on a rear surface of the mounting plate;
ii) an opening of a size for exposing the television screen of the television receiver,
iii) a first means for engaging, the first engaging means joining a lower portion of the mounting plate with a lower edge of the hole in the wall for supporting the mounting plate on the wall;
iv) a second means for engaging, the second engaging means enabled for locking and unlocking an upper portion of the mounting plate with an upper edge of the hole in the wall for holding the mounting plate within the hole in the wall.

2. The combination of claim 1 wherein the first engaging means is a bracket fixed to the rear surface of the mounting plate in a position adjacent to a lower edge thereof, the bracket providing a flange spaced apart from the mounting plate thereby forming a channel sandwiched about the lower edge of the mounting wall.

3. The combination of claim 1 wherein the second engaging means is a bar rotationally mounted on the rear surface of the mounting plate, the bar positionable for sandwiching the upper edge of the hole in the wall between the mounting plate and the bar for securing the mounting plate on the wall, the bar alternately positionable for releasing the upper edge of the hole in the wall for disengaging the mounting plate from the wall.

4. The combination of claim 1 further comprising at least one first aperture in the mounting plate and at least one loudspeaker mounted on the rear surface of the mounting plate for projecting sound through the at least one first aperture.

5. The combination of claim 1 further comprising at least one second aperture in the mounting plate and at least one remote signal sensor mounted on the rear surface of the mounting plate for receiving a remote signal through the at least one second aperture.

6. A wall mounted television receiver apparatus comprising:
a) a television receiver providing a television screen;
c) a mounting plate having:
i) a means for mounting the television receiver on a rear surface of the mounting plate;
ii) an opening of a size for exposing the television screen of the television receiver,
iii) a first means for engaging, the first engaging means for joining a lower portion of the mounting plate with a lower edge of a hole in a wall for supporting the mounting plate on the wall;
iv) a second means for engaging, the second engaging means enabled for locking and unlocking an upper portion of the mounting plate with an upper edge of the hole in the wall for holding the mounting plate within the hole in the wall.

7. The apparatus of claim 6 wherein the first engaging means is a bracket fixed to the rear surface of the mounting plate in a position adjacent to a lower edge thereof, the bracket providing a flange spaced apart from the mounting plate thereby forming a channel for sandwiching the lower edge of the mounting wall.

8. The apparatus of claim 6 wherein the second engaging means is a bar rotationally mounted on the rear surface of the mounting plate, the bar positionable for sandwiching the upper edge of the hole in the wall between the mounting plate and the bar for securing the mounting plate on the wall, the bar alternately positionable for releasing the upper edge of the hole in the wall for disengaging the mounting plate from the wall.

9. The apparatus of claim 6 further comprising at least one first aperture in the mounting plate and at least one loudspeaker mounted on the rear surface of the mounting plate for projecting sound through the at least one first aperture.

10. The apparatus of claim 6 further comprising at least one second aperture in the mounting plate and at least one remote signal sensor mounted on the rear surface of the mounting plate for receiving a remote signal through the at least one second aperture.

11. An apparatus for mounting a television receiver on a wall, the apparatus comprising: a mounting plate having:
i) a means for mounting the television receiver on a rear surface of the mounting plate;
ii) an opening of a size for exposing a television screen of the television receiver;
iii) a first means for engaging, the first engaging means for joining a lower portion of the mounting plate with a lower edge of a hole in the wall for supporting the mounting plate on the wall;
iv) a second means for engaging, the second engaging means for locking and unlocking an upper portion of the mounting plate with an upper edge of the hole in the wall for holding the mounting plate within the hole in the wall.

12. The apparatus of claim 11 wherein the first engaging means is a bracket fixed to the rear surface of the mounting plate in a position adjacent to a lower edge thereof, the bracket providing a flange spaced apart from the mounting plate thereby forming a channel for sandwiching the lower edge of the wall.

13. The apparatus of claim 11 wherein the second engaging means is a bar rotationally mounted on the rear surface of the mounting plate, the bar positionable for sandwiching the upper edge of the hole in the wall between the mounting plate and the bar for securing the mounting plate on the wall, the bar alternately positionable for releasing the upper edge of the hole in the wall for disengaging the mounting plate from the wall.

14. The apparatus of claim 11 further comprising at least one first aperture in the mounting plate and at least one loudspeaker mounted on the rear surface of the mounting plate for projecting sound through the at least one first aperture.

15. The apparatus of claim 11 further comprising at least one second aperture in the mounting plate and at least one remote signal sensor mounted on the rear surface of the mounting plate for receiving a remote signal through the at least one second aperture.

16. A method for mounting a television receiver in a wall comprising the steps of: forming a rectangular hole in the wall, the hole providing an upper edge and a lower edge; mounting a television receiver on a rear surface of a mounting plate; forming an opening in the mounting plate of a size for exposing a television screen of the television receiver; fixing a first means for engaging on the mounting plate and resting the first means for engaging with the lower edge of the hole; fixing a second means for engaging on the mounting plate and engaging the second means for engaging with the upper edge of the hole.

17. The method of claim 16 further comprising the steps of: forming the second engaging means as a bar; rotationally mounting the bar for alternately sandwiching the upper edge of the hole in the wall between the mounting plate and the bar for securing the mounting plate on the wall, and alternately positioning the bar for releasing the upper edge of the hole in the wall for disengaging the mounting plate from the wall.

18. The combination of claim 16 further comprising the step of forming at least one first aperture in the mounting plate; mounting at least one loudspeaker on the rear surface of the mounting plate; and projecting sound through the at least one first aperture.

19. The combination of claim 16 further comprising the step of forming at least one second aperture in the mounting plate; mounting at least one remote signal sensor on the rear surface of the mounting plate; and receiving a remote signal through the at least one second aperture.
